(19) United States
(12) Patent Application Publication
(10) Pub. No.: US 2022/0300636 A1
(43) Pub. Date: Sep. 22, 2022

(54) System And Method For Standardizing Data

(71) Applicant: Streamlytics Inc, Miami, FL (US)

(72) Inventors: Angela BENTON, Miami, FL (US); Candrianna COE, Montgomery, AL (US); Ahmed MAAWY, Mombasa (KE)

(21) Appl. No.: 17/207,405

(22) Filed: Mar. 19, 2021

(51) Int. Cl. G06F 21/62; G06F 16/9535

(52) U.S. Cl. CPC G06F 21/6227; G06F 16/9535; G06F 21/6245

(57) ABSTRACT

Systems and methods for standardizing data can be applied, for example, to generate user profiles, analyze consumer data, and/or combine information from a variety of sources. In embodiments, systems can comprise at least one computing device in communication with a database, such as a cloud database. The database can further store content identifiers, such as metadata. At least one data file associated with a user and at least one third-party content service provider can be received, converted from a first data format to a common format, analyzed to identify user information and attributes related to activity on a third-party content service provider. The database can be uploaded with user information and identified attributes to generate a profile comprising a subset of information from the cloud database, the subset of information comprising at least one attribute and user information.

### BACKGROUND

Consumer data comprises a collection of behavioral, demographic, engagement, and consumer information that can be generated and compiled from user activity. Content service providers, streaming services, social media services, online services, devices (e.g., computing, biometric, environmental, etc.), for example, can generate information such as consumer data, to analyze its user's activities, obtain information regarding customer preferences, identify trends, generally optimize operations to meet consumer preferences and needs, and make informed business decisions. Consumer data can also be obtained from a plethora of domains, including but not limited to real-time and/or live interactions, observations, records, communications, and methods utilizing computing devices.

Content providers, service providers, and devices can capture consumer data in a variety of collection methods, including but not limited to active methods, like requesting consumer input via surveys, and passive methods, like tracking activity on products and/or platforms. Compiling consumer data from a variety of sources (e.g., content providers) can provide a helpful, holistic overview of user activity and preferences, however combining such data into a useful, practical, and usable format can be challenging. Various services, providers and sources can collect consumer data and package the information in one or more data formats and modalities. In particular, consumer data files are typically provided in one or more file formats with no unified schema. The compiled information, e.g., consumer data profiles, and its data formats can also vary greatly between content service providers. As such, there can be challenges in combining the data from a variety of sources into a useful, practical format, for example, to analyze and apply the consumer into one or more applications.

In addition, the plurality of consumer data sources and formats can make it challenging for a user or consumer to manage, own, control, monetize, buy, sell, and/or transfer their data. For reasons such as privacy, business, financial, and personal considerations, among other concerns, users have become increasingly interested in, and even incentivized to, review, manage, and otherwise control their personal data. Due at least in part to the factors discussed above, consumer data management and aggregation is a challenge that is present across personal, individual levels to large scale environments having a plurality of individuals and/or sources.

### SUMMARY

Disclosed herein are systems and methods for standardizing data. Embodiments of the present invention can be applied to generate user profiles, for example, to analyze consumer data and/or combine information from a variety of sources. In embodiments, systems can comprise a computing device in communication with a cloud database. The computing device can comprise a processor, and at least one memory communicatively coupled to the processor. In embodiments, disclosed systems and methods can comprise instructions to at least: receive a data file associated with a user and at least one third-party content service provider, the data file comprising user information in a first data format; convert the data file from the first data format to a common format; analyze the converted data file to identify user information and attributes related to user activity on the at least one third-party content service provider; update the cloud database with the user information and identified attributes, wherein the cloud database comprises at least one of: data files associated with other users, metadata from a third-party content service provider, previously identified attributes, and user metadata; and generate a profile comprising a subset of information from the cloud database, the subset of information comprising at least one attribute and user information.

In various embodiments, the common format can be a universal data interchange format (UDIF) or JavaScript Object Notation (JSON). The first data format can be CSV, HTML, XML, PDF, TXT, DOC, DOCX, ZIP, XLS, XLSX, or JS, among others, such as those listed in Appendix A. In embodiments, the user information comprises one or more of: a name, user name, user activity data, video stream information, user communications, texts, biometric data, health data, demographic information, and metadata associated with the user. A list of additional data types usable in accordance with embodiments are also listed in Appendix A. The demographic information can include at least one of: an email, a phone number, a gender, a date of birth, and a zip code. In embodiments, the third-party content service provider can be at least one of: a social media network, a streaming service, an online account provider, a data management service, an online service, a health service, and a website, among others.

The data file in the first format can be stored in a second cloud database comprising data files and user information collected from a plurality of third-party service providers. Moreover, the data file can be uploaded via a user interface, such as a graphical user interface on a remote computing device. Embodiments in accordance with the present invention include computing devices being at least one of: a laptop, a personal computing device, a wearable computing device, and a mobile computing device.

In embodiments, converting the data format can further comprise: identifying a key associated with the first format of a data file; and executing a script based on the key to convert the data file to the common format. At least one of the generated profile and the converted data files can be stored in the cloud database, and in embodiments, at least one of a local database and a remote database. In further embodiments, a request for at least one attribute or user information of interest can be received, and a profile can be generated based on the request.

Embodiments of the present invention further include systems and methods for standardizing and processing user information. Such systems can comprise a computing device for uploading data files associated with a user on at least one third-party content service provider, wherein the data files comprise a first data format; a secure cloud database storing a plurality of content identifiers collected from at least one of: a plurality of data files, metadata from content service providers, and user input; and a processor in communication with at least one memory.

In embodiments, the memory comprises instructions that can cause the processor to at least: receive data files from the computing device; convert the data files to a common format; extract information indicative of user activity, based on previously identified content in the secure cloud database; process the user activity information and categorize based on user activity types; and output a subset of the user activity information to the computing device. Data files can comprise user information including, but not limited to, one or more of: a name, user name, user activity data, video stream information, user communications, texts, demographic information, biometric data, health data, metadata associated with the user, and information associated with one or data types, as listed in Appendix A. In embodiments, processing comprises storing, in the database, at least one of a user profile, user identifier, a data file location, an upload time, and an upload status.

Other features and advantages of the invention will be apparent from the detailed description that follows.

### BRIEF DESCRIPTION OF THE DRAWINGS

The following detailed description may be better understood when read in conjunction with the appended drawings. For the purposes of illustration, there are shown in the drawings example embodiments of various aspects of the disclosure; however, the invention is not limited to the specific methods and instrumentalities disclosed.

FIG. 1 illustrates the stages of data collection, storage and processing used to convert input files into a standardized and normalized format.

FIG. 2 illustrates a data collection mechanism that can accept input files from the user interface, enrich the data with related metadata, and store the files for processing.

FIG. 3 illustrates the storage layers used to securely store files both pre and post processing.

FIG. 4 illustrates the data processing stages executed to convert various file formats to the UDIF standard.

FIG. 5 illustrates the centralized API layer used to securely transfer the processed and sanitized data via API interfaces or data exports.

FIG. 6 illustrates the output schema used for data processing, data categorization and transformation.

FIG. 7 illustrates the REST API model, including the output data schema that is accessible via API.

FIG. 8 illustrates the data ingest process, including the data uploads through the user interface as well as backend data processing.

FIG. 9 illustrates a sample UDIF output for a stream activity type.

FIG. 10 illustrates a cloud computing system in accordance with embodiments.

FIG. 11 shows an example computing device which may be used to perform any of the techniques disclosed herein.

### DETAILED DESCRIPTION

The present systems and methods relate to systems and methods for standardizing data and generating profiles. Embodiments of the present invention comprise a computing device in secure communication with a cloud database, wherein the computing device comprises a processor, and at least one memory communicatively coupled to the processor, the memory comprising instructions that cause the processor to at least: receive a data file associated with a user and at least one third-party content service provider, wherein the data file comprises user information in a first data format; convert the data file from the first data format to a common format; analyze the converted data file to identify user information and attributes related to user activity on the at least one third-party content service provider; update the cloud database with the user information and identified attributes, wherein the cloud database comprises at least one of: data files associated with other users, metadata from a third-party content service provider, previously identified attributes, and user metadata; and generate a profile comprising a subset of information from the cloud database, the subset of information comprising at least one attribute and user information.

Embodiments of the present invention include a new file format that normalizes and standardizes consumer data into one format that can be easily downloaded or transferred into new or existing systems. This new format is based on a normalization schema. In embodiments, a processing script converts one or more existing file formats into a different file format, such as a Universal Data Interchange Format (“UDIF” or “.udif”). UDIF files can be based on JavaScript Object Notation (“JSON”) for example and can be read by existing popular readers.

Embodiments can be applied on the backend to prepare and read files before going into an API and/or sold. Processing scripts can also be implemented into software via API to make data handling and/or transference easier for software products.

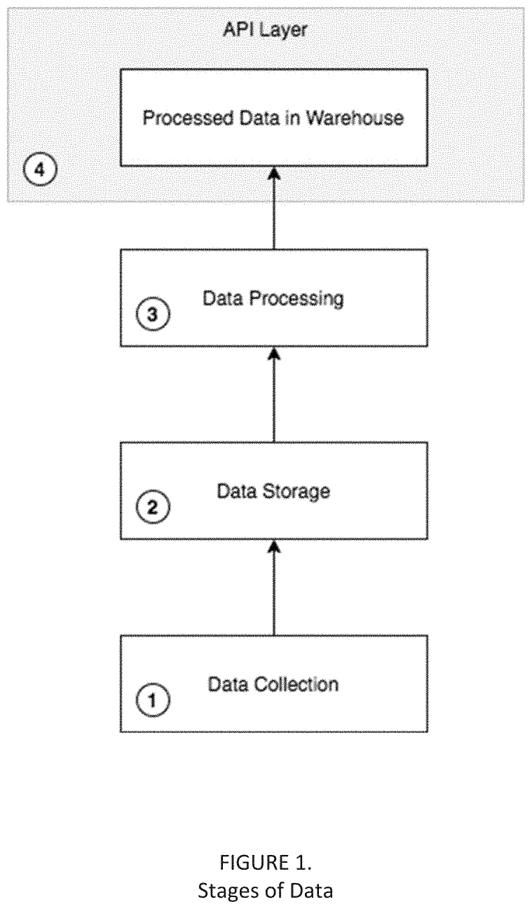

FIG. 1 illustrates various stages of data collection, storage and processing, in accordance with embodiments discussed herein. The process can be used, for example, to convert input files into a standardized and normalized format, such as a UDIF format.

In embodiments, data collection 1 occurs, during which data files from any of a variety of formats and sources can be compiled. Data collection 1 can comprise a data collection mechanism, such as a manual and/or automatic collection of data files. In examples, a user can upload data files via a user interface on a computing device and uploaded data files are collected in one or more data stores or memories, as discussed herein. Users can upload data via any of a variety of electronic computing devices, such as a laptop or smartphone. Data collection can comprise data generated from one or more programs, operations, and software executing on a computing device, can comprise data passively or actively collected, e.g., user input, biometric data observations, environmental data collection, metadata, data collected over one or more periods of time, and any of a variety of manual and/or automatic collection methods for information.

The collected data can be stored in one or more data storage 2 devices, including but not limited to a database, cloud storage system, and a memory. Such data storages can occur on or more devices, which can comprise local and/or remote systems and methods. For example, data storage can occur using at least one remote server, which can be part of a cloud-based system, as further discussed herein.

In embodiments, a series of data storage layers can be implemented to securely store raw and/or processed data. Such data storage layers can comprise one or more of a data warehouse, cloud storage buckets, local data management systems, and the like.

Data processing 3 occurs on the stored data in one or more of the data storage systems. Data processing can include, for example, one or more stages to convert multiple file formats into a standardized format, such as a UDIF format. One or more processing scripts can be implemented process data into a desired format.

In various embodiments, data processing can contain one or more of:
A processing script that converts CSV (Comma Separated Values) files to UDIF (Universal Data Interchange Format) files
A processing script that converts HTML (Hypertext Markup Language) files to JSON (JavaScript Object Notation) files
A processing script that converts PDF (Portable Document Format) files to JSON (JavaScript Object Notation) files
A processing script that converts XML (Extensible Markup Language) files to (JavaScript Object Notation) JSON files
A processing script that converts JSON (JavaScript Object Notation) files to UDIF (Universal Data Interchange Format) files

In addition to the above, data processing in accordance with present embodiments can comprise conversions between any of the data types and file formats listed in Appendix A. It will also be appreciated that any of a plurality of data types and file formats can be utilized in accordance with embodiments. Systems, methods, and embodiments of the present invention can be applied to various data formats, such that a first data format or data type can be standardized into a desired format.

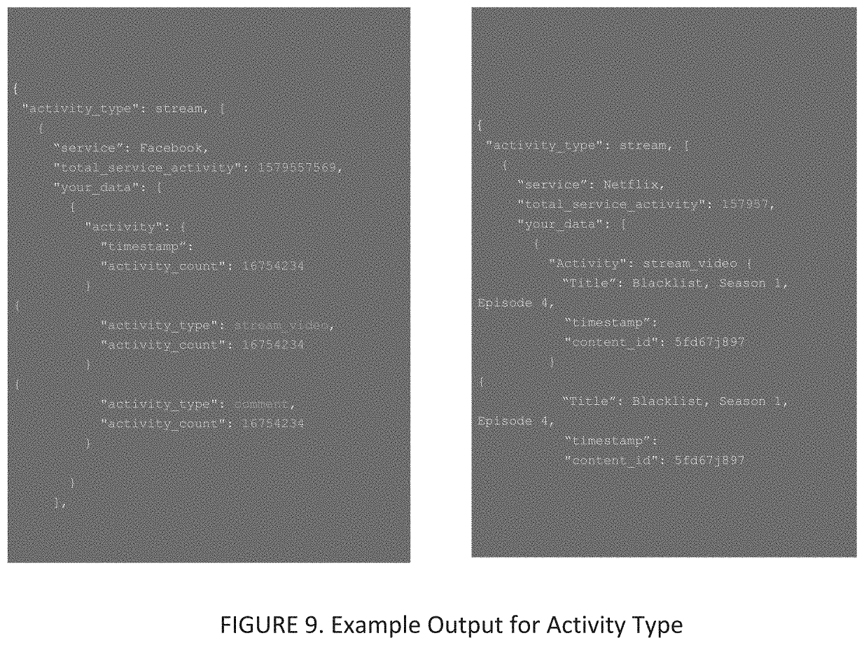

In accordance with embodiments of the present invention a processing path for a file format conversion can occur as follows. Data files are uploaded, transferred, and/or received. The data files can be converted into a particular data structure, such as an array. A processing script, which can include but are not limited to one or more of those discussed above, identifies specific keys associated with an existing file format. Such keys can vary based on one or more of the service provider, the file format, and other factors. These existing file format keys are then reassociated with one or more keys associated with the desired file format. For example, in a processing script to convert a format to a UDIF format, existing keys from the original format are identified and reassociated with UDIF standard keys. The data structure, e.g., array, can then be converted to the desired file format, e.g., a .udif file. FIG. 9 further illustrates an example UDIF output and standard keys usable with data file conversions, discussed herein.

In embodiments, such as a UDIF file conversion, each file format can generate a new .udif file based on the processor that is used. In an example, all UDIF Files can be compiled into one UDIF. As such, the compiled UDIF can hold a complete collection of an individual or entity's data.

It will be appreciated that the embodiments of the present invention are not limited to the data processing and file conversion examples noted and discussed above, and any of a plurality of processing scripts and data formats can be applied, and still fall within the scope of the present invention.

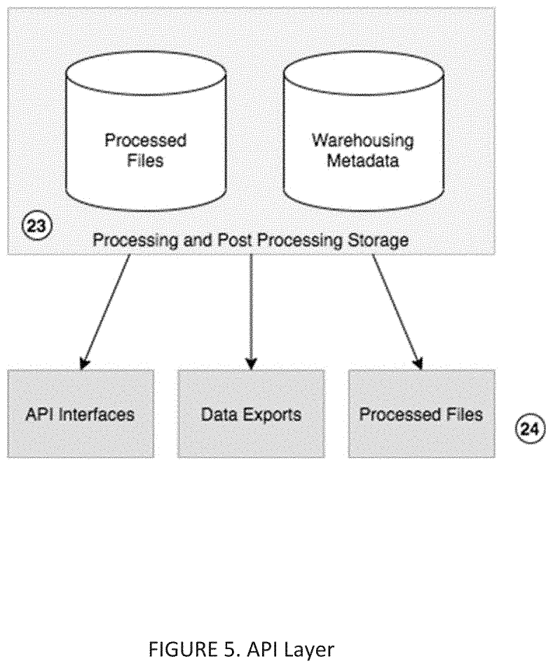

In embodiments, an API layer 4 can be implemented to store and/or deliver processed data to one or more output destinations, as further discussed herein, with reference to at least FIGS. 5-7.

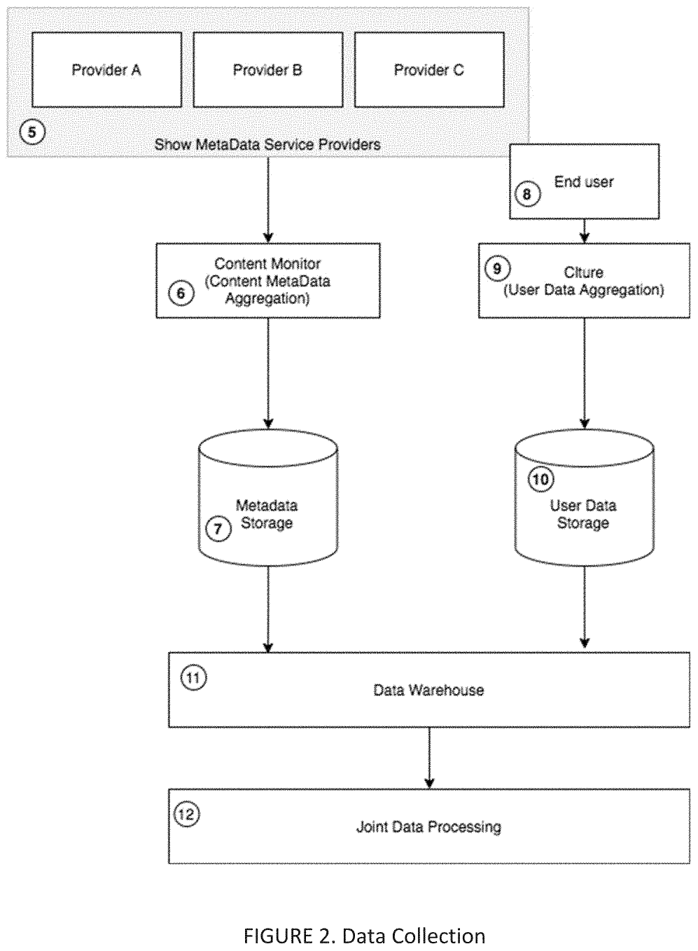

FIG. 2 illustrates a data collection mechanism that can accept input files from the user interface, enrich the data with related metadata, and store the files for processing. As discussed herein, user data and metadata can be collected from one or more sources. Such sources can be metadata service providers 5, which can comprise a plurality of Providers: Provider A, B, C, n. These providers can be third-party service providers, including but not limited to content service providers. The providers can provide metadata, e.g., related to user activity associated with aggregated user data 9. Such metadata can be obtained for an exemplary purpose of enriching user data, e.g., collected user data, and can be associated with one or more aspects and/or attributes of the user data.

In an example, metadata with respect to a user activity can be pulled from one or more separate third-party sources. Such metadata enrich the collected and/or uploaded data files. For example, collected data can include a user's streaming activity on a streaming service, such as Netflix, Hulu, YouTube, and the like. Metadata can be pulled from other third-party sources, like Wikipedia and/or Amazon, to provide additional information about an aspect and/or attribute of the streaming activity, such as a particular show that the user watched, a show title, a product name, and the like.

In another example, Provider A can also provide a user data file related to user searches or interactions, e.g., on Wikipedia, Provider B can provide information related to user activity, e.g., on IMDB, and Provider C can provide data related to a user's activity, e.g., purchase history, search history, etc., at an online store, e.g., Amazon. Examples of metadata from obtained from those Providers can include data related to and/or otherwise associated with the searches, products, and information contained in the user data. For example, metadata related to a product purchased by a user can include product information, rating, and reviews.

Metadata enrichment further serves to provide more detail and context on the collected data files and content categories. In embodiments, a unique identifier can be associated with collected data enriched with metadata. For example, for user streaming data enriched with metadata based on the content (e.g., a show title or product name), and a unique identifier can be assigned to each distinct content title. In embodiments, metadata catalogues can be stored in a secure cloud database with unique content identifiers.

As illustrated in FIG. 2, a content monitor 6 can serve as a content metadata aggregation. The content monitor can aggregate the metadata and associations, e.g., with aspects of the collected user data file, and store the information in a metadata storage 7. The storage can comprise one or more local and/or remote databases, as discussed herein.

An end user 8 can provide data for user data aggregation 9. In an example, an end user requests data files from various service providers for uploading via a user interface via a laptop or mobile device. Such user data files, can be actively or passively uploaded to a server and/or storage 10 of claimed embodiments as discussed herein.

In embodiments, user data files can be uploaded to a graphical user interface (GUI), such as Clture, which serves as a focal point for user data aggregation. The GUI can comprise a profiler collecting, for example, self-reported user demographic information, which can be further processed and/or sanitized.

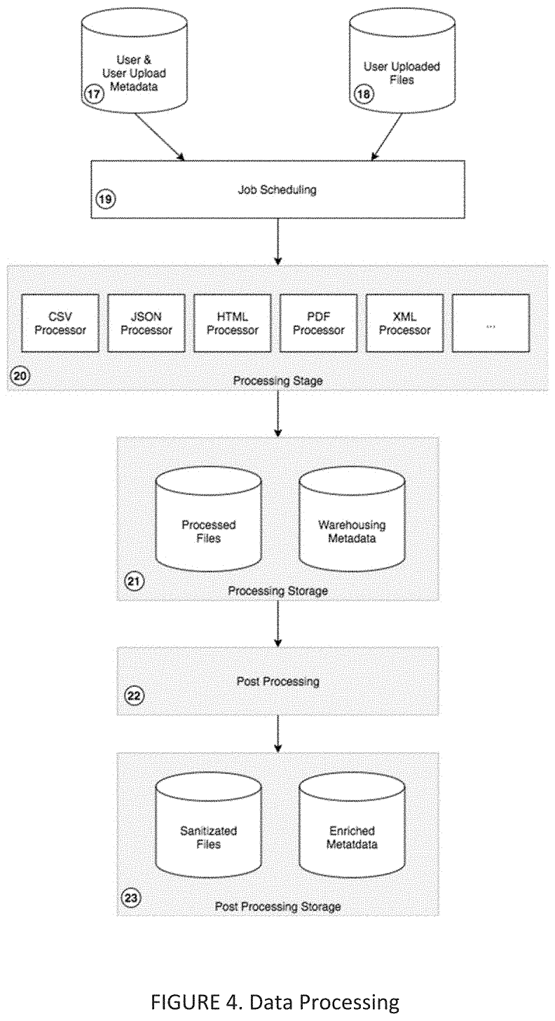

In examples, user data, such as demographic data, can be stored in a secure cloud database, with entries being assigned a unique user identifier. Similar to the metadata storage, user uploads can be stored in secure cloud storage buckets and prepared for processing. A secure cloud database can also be used as a data like to store a combination of one or more of metadata, user information, uploads and processing logs. In accordance with embodiments, one or more databases, remote, local, cloud, or otherwise, can be used to store any of a combination of metadata and user data. In other embodiments a same or additional cloud database(s) can be used to store metadata against items related to the user data store. It will be appreciated that the metadata and user data storage databases can comprise any of a combination of one or more storage devices and configurations. A data warehouse 11 can compile the collected data for joint data processing 12, as discussed herein, at least with respect to FIG. 4.

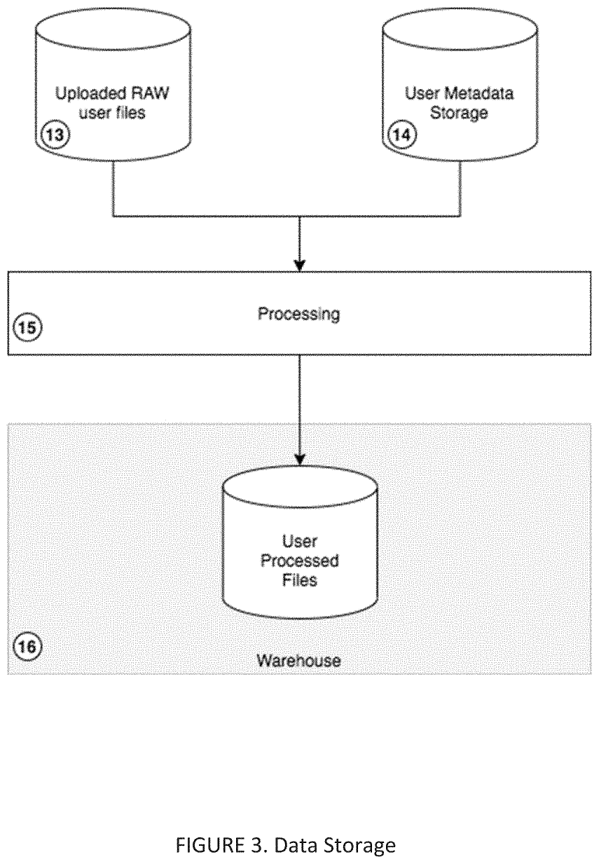

FIG. 3 illustrates an exemplary configuration with respect to data storage. Uploaded raw user files 13 and user metadata storage 14 can undergo processing prior to being stored in a warehouse 16, comprising any one or a combination of database types and structures. The user processed files in the warehouse 16, for example, may have undergone processing 15 to unify one or more aspects related to a file type, aspect, or association.

FIG. 4 illustrates an example of detailed processing steps through which the collected data can undergo. During the illustrated workflow, data processing can be executed to transform uploaded files to a standardized format, such as a UDIF format. In addition, the data processing step can update content with metadata where appropriate.

In an example, the user and user uploaded metadata 17 and the user uploaded files 18 can be uploaded via a graphical user interface (GUI) and stored in a storage bucket, such as a secure cloud storage bucket for processing. In various embodiments, collected information about a user can include, but is not limited to demographic information, such as an email, phone number, gender, date of birth, and zip code.

In embodiments, the raw data 17, 18 can first undergo a job scheduling process 19 to determine when and how such files are processed. As discussed above, user demographic data and metadata associated with user uploads are stored in a secure cloud database. Unique identifiers can be assigned to each user, upload item, and/or content item.

In the job scheduling process 19, job can be scheduled to ensure that uploaded files are continuously moved to the processing stage in near real time. As unique content titles are extracted from uploaded files, a content monitor can identify the appropriate metadata and add a universal metadata catalogue for the purpose of data enrichment in the post-processing stage.

During a processing stage 20, the uploaded files are modified to a desired format. In various embodiments, one or more processors can be implemented to modify the files. A series of processing scripts can be executed to convert various data files to a standard format. Examples of processors can include, but are not limited to, a CSV processor, JSON processor, HTML processor, PDF processor, XML, processor. Additional processors may be incorporated to process additional file types. One or more processors can be used to process each file type as well. For example, two or more processors can be applied to process CSV files. Likewise, one or more processors can be implemented to process multiple file types. For example, a single processor can process any of a combination of file types. In embodiments, the processing is scheduled to run continuously and processed contents can be later enriched, sanitized, and exposed via an API.

Data processing can also serve to transform uploaded files into a standardized UDIF format. Regardless of the type of data processing, the processed data can be enriched with metadata where appropriate and/or desired. For example, the user data can be enriched with specific metadata for each content item (e.g., TV shows, movies, products, etc.)

Processed files are the stored in a processing storage 21. In embodiments the processing storage comprises one or more databases and/or storage structures to store at least one of the processed files and metadata. Processed uploads can be renamed and stored on a secure cloud storage bucket, for example. In embodiments, separate databases can be used to store the processed files and to warehouse the metadata. In other embodiments, the content monitor can grab unique content titles from processed files, and add any appropriate metadata to the content catalog for enrichment i the post-processing phase. Any of a combination of storage types, numbers, and structures are intended to fall within the scope of the invention. It will be appreciated that various configurations and types of storage architectures can be implemented in accordance with embodiments discussed herein, and can be adapted, adjusted, and/or modified depending on, for example, various computing architectures, available resources, desired implementation and output.

In embodiments, the processed data, including both the processed user files and metadata, can undergo post processing 22. Processed user uploads can be renamed and/or stored, in embodiments, in secure cloud storage buckets or remote or local storage buckets with a correspond “destination url” that is maintained throughout processing logs to indicate the location of each file. Detailed logs and storage location information for each raw and processed upload can be stored in a secure warehouse, such as a cloud data warehouse. In embodiments, a processing “status” can be assigned to each upload within a warehouse log to indicate if the file was successfully processed. In other embodiments,

In embodiments, user demographic information can be collected via a profiler, such as a GUI profiler, and the content monitor can identify and aggregate metadata to be used in the enrichment step post processing. In addition, uploaded files can be received from the GUI and stored securely in a cloud storage bucket while the raw files are prepared for processing.

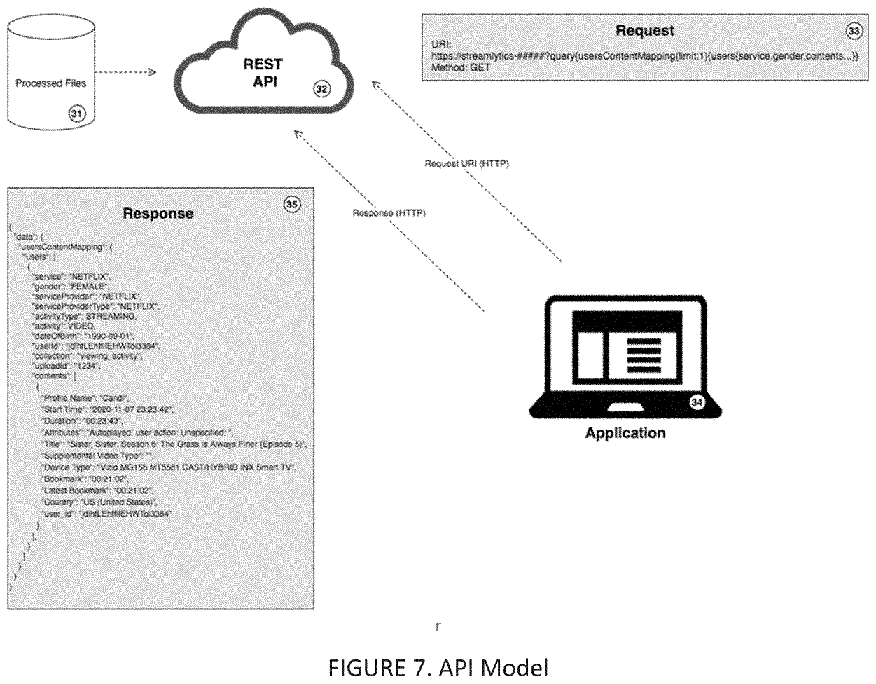

Once the various file types are processed, standardized, and securely stored, post-processing steps can prepare data for delivery to an API. Processed files can also be sanitized by removing sensitive and/or other personal identifying information (PII), and hashing other identifiable information. User uploads are also enriched using metadata retrieved from the content monitoring system. In addition, processed files can be categorized into a series of collections, e.g., based on file naming conventions. Such collections can be used to indicate various activity types (e.g., streaming video, streaming audio, gaming, etc.) across each service. Processed and categorized file uploads can further be stitched together with user information, e.g., sanitized user information, to build the primary view accessed by the API. This schema is further detailed with respect to FIG. 7.

Post-processing storage 23 contains both sanitized files and enriched metadata. The sanitized and processed data on user and user uploads can be saved for example, in a secure cloud storage bucket alongside enriched content metadata. Details on these processed files are stored in a database and accessible via an API, as illustrated, for example, in FIG. 5. In addition, a log of uploaded user can be maintained in the database, such that for each upload from one or more services, a distinct user identifier is documented with the entry, along with a location of the file in the storage bucket, the time the file was uploaded, and a status to indicate whether the file has been processed. A log of all processed files can be maintained within the database along with a status to indicate the processing state of each user upload.

Alongside a record of processed files, a record is maintained, which comprises timestamps indicating when processing has occurred. Such data processors can run continuously as files are uploaded through the interface.

FIG. 5 illustrates an API layer through which processed files can be accessed. In embodiments, the processing and post-processing storage 23 can deliver the data to output destinations such as API interfaces, data exports, and processed files 24. In embodiments, the API can read from the storage database 23. The database can store user information together with each processed user upload. Moreover, the aggregated data can be queried via an API, for example, thus allowing for several filters and mutations to drill down specific activity types.

The output destinations can each comprise one or more file output types comprising the data. In examples, the processing and post processing storage operations can result in a data file, such as a user profile being generated, which can comprise a subset of information. The subset of information can contain user information, and at least one attribute related to user activity or user information on a service provider, for example. The output format of the processing and post processing storage can vary, depending on the desired data format type, a type of information, and/or an intended purpose or destination of the data. Such data outputs 24 can be applicable for display, interaction, or further processing in connection with an API interface. Data exports can comprise one or more files with a subset of information, and can be stored in one or more databases, such as a cloud database, in embodiments. Similarly, processed files can be stored in one or more databases, which can be the same or different as any stored information from data export. It will be appreciated that any subset of processed files and data, including user data, certain data types, data formats, and so forth can be compiled into one or more data structures and formats.

Moreover, in examples, the one or more API layers are able to be exposed, in order to ensure secure and efficient transfer and handling of data. And the API layer, for example allows the aggregated standardized files, e.g., UDIF files, to be delivered in a variety of means, such as an exported file via a GUI or through a programmatic access via the API.

In embodiments, the API can be accessible via GUI for data export. In other embodiments, a request can be made programmatically, such as through a client application. In embodiments, the API response is returned in a structured schema, which can provide sanitized user details, information on services, activity types, and collections, as well as detailed contents and the uploaded file(s). A contents array can contain detail about specific data points within a file upload. Such specific data points can vary based on the type and format of data, such as video streaming data, shopping data, and e-reading data, among others. In a case where a product is associated with a data point, metadata can be attached to the contents, such as a show title or a product name.

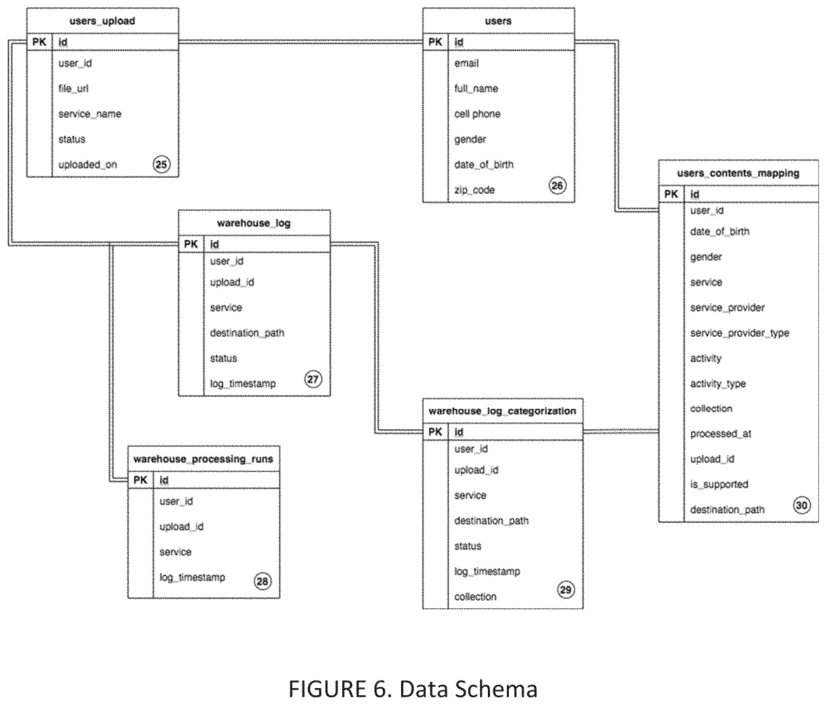

FIG. 6 illustrates a data schema in which embodiments of the present invention may be implemented. The data schema comprises a plurality of buckets of information through which data can be identified and associated with. In the depicted embodiment, user uploads can comprise one or more tags and/or associations indicating a user id, file URL, a service name, status, and upload setting.

Users can have associated information indicating one or more of an email, full name, cell phone number, gender, date of birth, and zip code, among others. The user contents mapping can comprise on or more of a user ID, date of birth, gender, service, service provider, service provider type, activity, activity type, collection, “processed at” location information, upload ID, “is_supported” information, and a destination path. A warehouse log can comprise a user ID, upload ID, service, destination path, status, and log timestamp. Moreover, a warehouse log categorization can comprise a user ID, upload ID, service, destination path, status, timestamp, log, and collection. Information regarding warehouse processing runs comprises a user ID, upload ID, service, and log_timestamp.

In embodiments, a subset of the data can be compiled to form one or more user profiles, containing desired information. It will be appreciated that the data schema illustrated in FIG. 6 is an exemplary embodiment, and that other embodiments in accordance with the present invention can comprise any variety of the disclosed components, and/or additional information and labels related to the user data.

FIG. 7 illustrates an API model, in accordance with embodiments discussed herein. As illustrated, an application can run on a computing device, such as a laptop, desktop, mobile computing device and the like. Request URLs and responses can comprise HTTP-based information. Requests and responses can interact with a cloud-based system, such as Rest API 21. Processed files are accessible by the API 32 and deliverable to the application 34 running on the computing device.

In a non-limiting example, interaction via an application 34 on a computing device or other user interface can execute a request. The request can be, for example, a request for a type of information (information associated with one or more users, one or more data types, one or more attributes related to user activity, etc.). The request can be performed, for example, through a website, URL, online platform, computing program, application, and the like. In embodiments, the request interacts with an API 32, in communication with one or more servers, databases and/or storage buckets containing processed files 31. The API functions to perform one or more actions of: compiling the requested information, standardizing data, if necessary, generating an output file, such as a profile with the requested information, and delivering the requested information in a response 35, back to the application interface 34. The response 35 can take any of a plurality of formats, such as a standardized data format, as discussed herein, and contain requested information, such as user data, user activity information, and the like. It will be appreciated that embodiments are not limited to the example discussed herein, and any of a plurality of steps, operations, requested data, delivered data, profile types, and data standardization and generation methods can be used in accordance with the present disclosure.

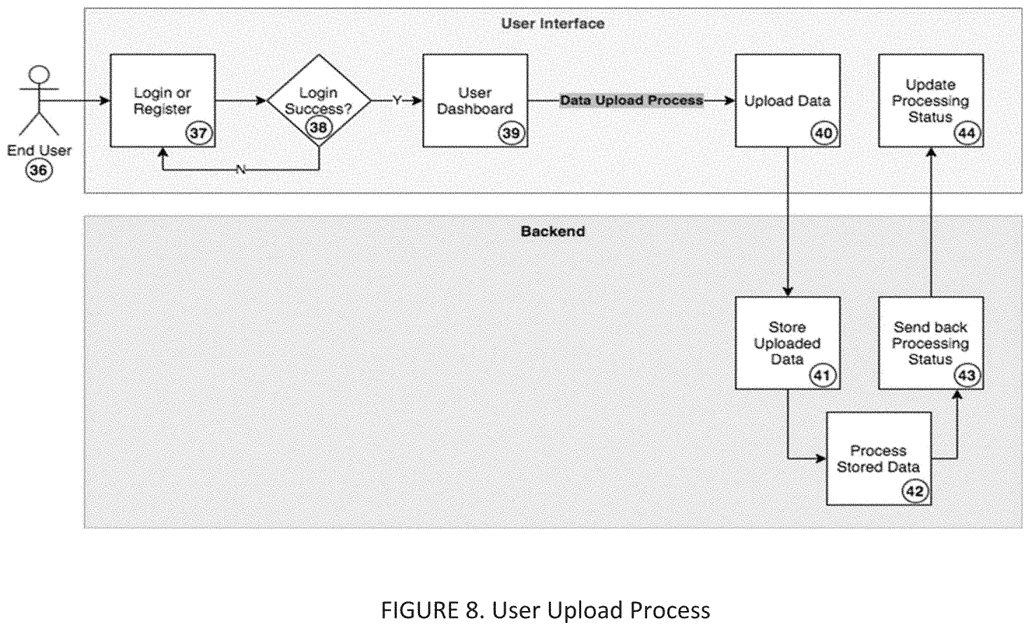

FIG. 8 illustrates a user upload process in accordance with embodiments of the present invention. In embodiments, an end user 36 can log-in or register 37 via an application operating on a user interface, including but not limited to a single-page application that is accessible via mobile devices and laptops. In accordance with embodiments, the user interface can further comprise a variety of visual and interactive formats, executable on a computing device, and may be implemented via one or more APIs. Users can authenticate via a plurality of means and methods, including but not limited to a login page, a two-step verification process, using a number, such as a cell number, and/or other identifier. It will be appreciated, however, that a password is not necessarily needed to login to the platform.

In an attempted login, the application determines a login success 38. If the login is successful, the user will be directed to a user dashboard 39. If the login is unsuccessful, the user will be directed back to the login page to reattempt to login or register 37.

After a successful login attempt, the user is directed to a dashboard 39 that allows a user to upload data 40 to the platform. The platform can comprise instructions on how to request data files. Once data files have been received from each service, users upload data files to the user interface, and are able to see the status of each uploaded file on the dashboard.

As files are uploaded through the user interface, they are stored 41 in a secure cloud storage bucket to make them accessible for further data processing. In embodiments, user files can go through the data processing steps 42, such as those discussed with respect to FIG. 4, to transform the uploaded files into a standardized format, such as a UDIF format.

When the file processing has completed, the status of the upload is updated on the backend to either “DONE PROCESSING” or “NEEDS REVIEW.” Any file marked as “NEEDS REVIEW” is further reviewed and processed. After the upload status is updated on the backend, the processing status is sent back 43 to the user interface, and the user interface is updated to reflect the file processing status documented in the backend 44. In various embodiments, user have an option to export the standardized UDIF file via the user interface.

FIG. 9 illustrates a sample UDIF output for a stream activity type. As discussed above, at least with respect to FIG. 1, data format conversions can identify one or more keys associated with an existing format, and reassociate the identified keys to standard keys in the desired file format. The sample output can be tailored to compile and/or output desired information. In embodiments, the output can comprise one or more of: an activity type, a service type, content manager name, service activity information, a timestamp, an activity count, and content identifier. One or more keys and/or identifiers can be associated with information and data collected as part of the UDIF output.

Table 1, below, illustrates non-limiting examples of UDIF standard keys that can be used in accordance with embodiments.

TABLE 1
UDIF Standard Keys

| | |
|---|---|
| SERVICE | Service data exported/uploaded from. |
| | Ex: Facebook, Netflix, etc. |
| ACTIVITY_TYPE | This will be the main classifier. We will classify |
| | all data by type then by service. Activity types |
| | include: stream, search, locations, social, |
| | financial, health. |
| TIMESTAMP | Timestamp of activity/datapoint |
| TOTAL_SERVICE_ | Equal to the number of timestamp counts. # of |
| ACTIVITY | data points by service |
| TYPE | This would be the user interaction. Types include: |
| | Like, Comment, Save, View/Video, Listen/Audio, |
| | etc. For Location data type it would be: Still, on |
| | foot, unknown, in vehicle, on bicycle, tilting. |
| LONGITUDE, | Longitude and latitude data. Usually accompanied |
| LATITUDE | by a timestamp. Typically received from a device |
| | like a phone or ride sharing service or a car. |
| YOUR_DATA | Activity breakdown |
| ACTIVITY | Differentiates from activity data and demographic |
| | or personal data. |
| METADATA | Includes content level metadata keys: title, date, |
| | genre, length, talent, etc. |
| CONTENT_ID | Used to pull metadata by title from content |
| | monitor |

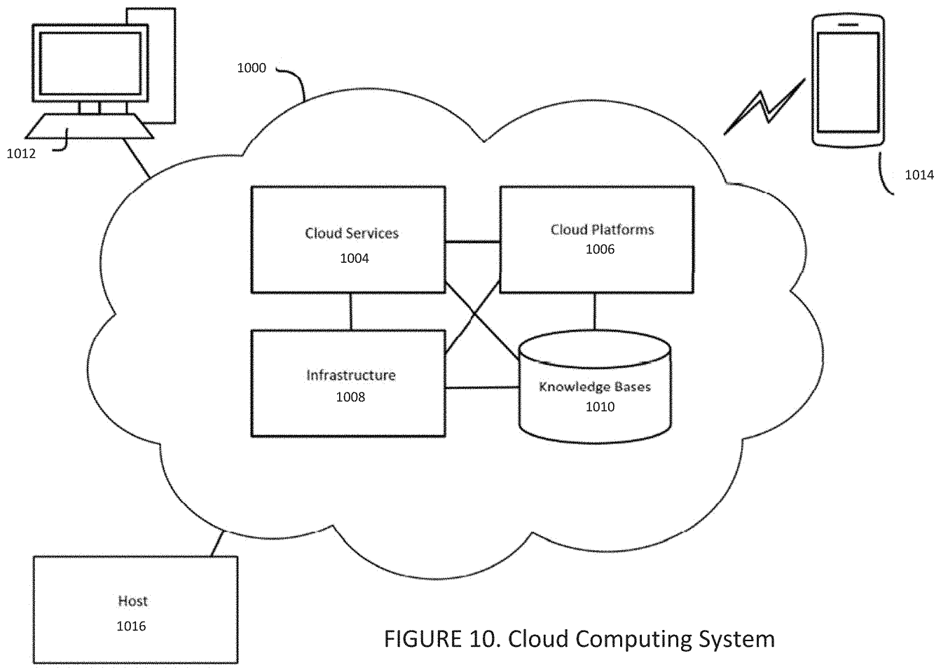

FIG. 10 shows example components of a cloud computing system 1000. By way of example and without limitation, cloud computing system 1000 may be used to perform aspects of the disclosed subject matter. Cloud-based computing generally refers to networked computer architectures where application execution, service provision, and data storage may be divided, to some extent, between clients and cloud computing devices. The “cloud” may refer to a service or a group of services accessible over a network, e.g., the Internet, by clients, server devices, and by other cloud computing systems, for example.

In one example, multiple computing devices connected to the cloud may access and use a common pool of computing power, services, applications, storage, and files. Thus, cloud computing enables a shared pool of configurable computing resources, e.g., networks, servers, storage, applications, and services, that may be provisioned and released with minimal management effort or interaction by the cloud service provider.

As an example, a cloud-based application may store copies of data and/or executable program code in the cloud computing system, while allowing client devices to download at least some of this data and program code as needed for execution at the client devices. In some examples, downloaded data and program code may be tailored to the capabilities of specific client devices, e.g., a personal computer, tablet computer, mobile phone, and/or smartphone, accessing the cloud-based application. Additionally, dividing application execution and storage between client devices and the cloud computing system allows more processing to be performed by the cloud computing system, thereby taking advantage of the cloud computing system's processing power and capability, for example.

Cloud-based computing can also refer to distributed computing architectures where data and program code for cloud-based applications are shared between one or more client devices and/or cloud computing devices on a near real-time basis. Portions of this data and program code may be dynamically delivered, as needed or otherwise, to various clients accessing the cloud-based application. Details of the cloud-based computing architecture may be largely transparent to users of client devices. By way of example and without limitation, a PC user device accessing a cloud-based application may not be aware that the PC downloads program logic and/or data from the cloud computing system, or that the PC offloads processing or storage functions to the cloud computing system, for example.

In FIG. 10, cloud computing system 1000 includes one or more cloud services 104, one or more cloud platforms 1006, cloud infrastructure components 1008, and cloud knowledge bases 1010. Cloud computing system 1000 may include more of fewer components, and each of cloud services 1004, cloud platforms 1006, cloud infrastructure components 108, and cloud knowledge bases 1010 may include multiple computing and storage elements as well. Thus, one or more of the described functions of cloud computing system 1000 may be divided into additional functional or physical components, or combined into fewer functional or physical components. In some further examples, additional functional and/or physical components may be added to the examples shown in FIG. 10. Delivery of cloud computing based services may involve multiple cloud components communicating with each other over application programming interfaces, such as web services and multi-tier architectures, for example.

Example cloud computing system 1000 shown in FIG. 10 is a networked computing architecture. Cloud services 1004 may represent queues for handling requests from client devices. Cloud platforms 1006 may include client-interface frontends for cloud computing system 1000, such as client-interface frontends of a messaging service. Cloud platforms 1006 may be coupled to cloud services 1004 to perform functions for interacting with client devices. Cloud infrastructure 108 may include service, billing, and other operational and infrastructure components of cloud computing system 1000. Cloud knowledge bases 1010 are configured to store data for use by cloud computing system 1000, and thus, cloud knowledge bases 1010 may be accessed by any of cloud services 1004, cloud platforms 1006, and/or cloud infrastructure components 1008.

Many different types of client devices, such as devices of users of the messaging service, may be configured to communicate with components of cloud computing system 1000 for the purpose of accessing data and executing applications provided by cloud computing system 1000. For example, a computer 1012, a mobile device 1014, and a host 1016 are shown as examples of the types of client devices that may be configured to communicate with cloud computing system 1000. Of course, more or fewer client devices may communicate with cloud computing system 1000. In addition, other types of client devices may also be configured to communicate with cloud computing system 1000 as well.

Computer 1012 shown in FIG. 10 may be any type of computing device, e.g., PC, laptop computer, tablet computer, etc., and mobile device 1014 may be any type of mobile computing device, e.g., laptop, smartphone, mobile telephone, cellular telephone, tablet computer, etc., configured to transmit and/or receive data to and/or from cloud computing system 100. Similarly, host 1016 may be any type of computing device with a transmitter/receiver including a laptop computer, a mobile telephone, a smartphone, a tablet computer etc., which is configured to transmit/receive data to/from cloud computing system 1000.

In FIG. 10, communication links between client devices and cloud 1000 may include wired connections, such as a serial or parallel bus, Ethernet, optical connections, or other type of wired connection. Communication links may also be wireless links, such as Bluetooth, IEEE 802.11 (IEEE 802.11 may refer to IEEE 802.11-2007, IEEE 802.11n-2009, or any other IEEE 802.11 revision), CDMA, 3G, GSM, WiMAX, or other wireless based data communication links.

In other examples, the client devices may be configured to communicate with cloud computing system 100 via wireless access points. Access points may take various forms. For example, an access point may take the form of a wireless access point (WAP) or wireless router. As another example, if a client device connects using a cellular air-interface protocol, such as CDMA, GSM, 3G, or 4G, an access point may be a base station in a cellular network that provides Internet connectivity via the cellular network.

As such, the client devices may include a wired or wireless network interface through which the client devices ma connect to cloud computing system 1000 directly or via access points. As an example, the client devices may be configured to use one or more protocols such as 802.11, 802.16 (WiMAX), LTE, GSM, GPRS, CDMA, EV-DO, and/or HSPDA, among others. Furthermore, the client devices may be configured to use multiple wired and/or wireless protocols, such as “3G” or “4G” data connectivity using a cellular communication protocol, e.g., CDMA, GSM, or WiMAX, as well as for “WiFi” connectivity using 802.11. Other types of communications interfaces and protocols could be used as well.

The above described aspects of the disclosure have been described with regard to certain examples and embodiments, which are intended to illustrate but not to limit the disclosure. It should be appreciated that the subject matter presented herein may be implemented as a computer process, a computer-controlled apparatus or a computing system or an article of manufacture, such as a computer-readable storage medium.

Those skilled in the art will also appreciate that the subject matter described herein may be practiced on or in conjunction with other computer system configurations beyond those described herein, including multiprocessor systems, microprocessor-based or programmable consumer electronics, minicomputers, mainframe computers, handheld computers, personal digital assistants, e-readers, cellular telephone devices, biometric devices, mobile computing devices, special-purposed hardware devices, network appliances, and the like. The embodiments described herein may also be practiced in distributed computing environments, where tasks are performed by remote processing devices that are linked through a communications network. In a distributed computing environment, program modules may be located in both local and remote memory storage devices.

A number of different types of computing devices may be used singly or in combination to implement the resources and services in different embodiments, including general-purpose or special-purpose computer servers, storage devices, network devices, and the like. In at least some embodiments, a server or computing device that implements at least a portion of one or more of the technologies described herein, including the techniques to implement the functionality of aspects discussed herein.

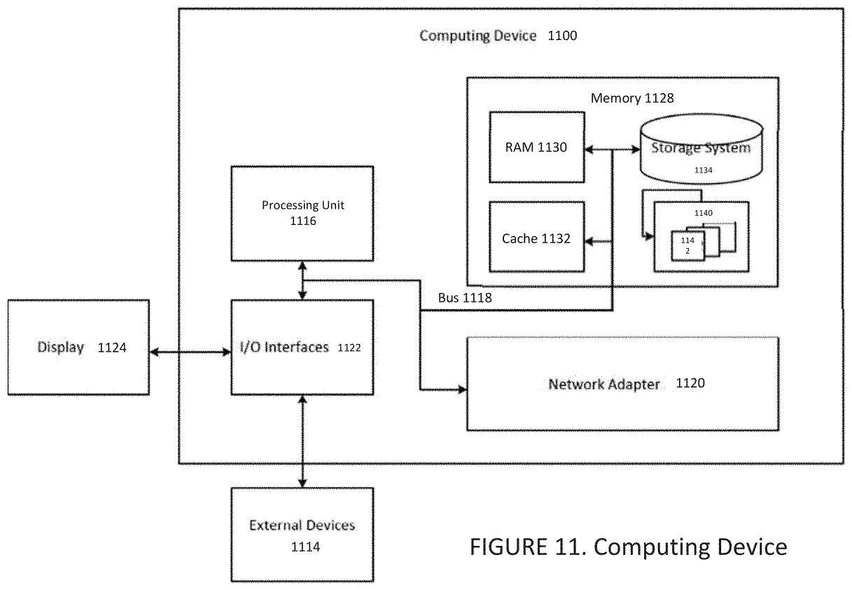

FIG. 11 shows such a general-purpose computing device 1100. The computing device 1100 may operate in a virtual environment, such as the environment 1000 in FIG. 10. Computing device 1100 may be used to host the messaging service or the messaging application. Computing device 1100 may be configured to communicate with devices of users of the messaging application. Computing device 1100 may be a general-purpose computing device. Computing device 1100 may be an on-premises device, such as a node of a distributed system running in a user's data center. The components of computing device 1100 may include, but are not limited to, one or more processors or processing units 1116, a system memory 1128, and a bus 1118 that couples various system components including system memory 1128 to processor 1116.

The bus 1118 in the example of FIG. 11 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (‘ISA’) bus, Micro Channel Architecture (‘MCA’) bus, Enhanced ISA (‘EISA’) bus, Video Electronics Standards Association (‘VESA’) local bus, and Peripheral Component Interconnects (‘PCI’) bus.

Computing device 1100 may include a variety of computer system readable media. Such media may be any available media that is accessible by computing device 1100, and it includes both volatile and non-volatile media, removable and non-removable media. Computing device 1100 may include system memory 1128, which may include computer system readable media in the form of volatile memory, such as random access memory (‘RAM’) 1130 and/or cache memory 1132. Computing device 1100 may further include other removable/non-removable, volatile/non-volatile computer system storage media. By way of example only, a storage system 1134 may be provided for reading from and writing to a non-removable, non-volatile magnetic media (not shown and typically called a “hard drive”). Although not shown, a magnetic disk drive for reading from and writing to a removable, non-volatile magnetic disk, e.g., a “floppy disk,” and an optical disk drive for reading from or writing to a removable, non-volatile optical disk such as a CD-ROM, DVD-ROM or other optical media may be provided. In such instances, each may be connected to bus 1118 by one or more data media interfaces. As will be further depicted and described below, memory 1128 may include at least one program product having a set, e.g., at least one, of program modules that are configured to carry out the functions of embodiments of the invention.

Computing device 1100 may include a program/utility 1140 having a set (at least one) of program modules 1142 that may be stored in memory 1128. Computing device 1100 of FIG. 11 may also include an operating system, one or more messaging application programs, other messaging application program modules, and messaging application program data. Each of the operating system, one or more messaging application programs, other messaging application program modules, and messaging application program data or some combination thereof, may include an implementation of a networking environment, such as the cloud computing system 100 in FIG. 1. Program modules 1142 generally carry out the functions and/or methodologies of embodiments of the invention as described herein.

Computing device 1100 of FIG. 11 may also communicate with one or more external devices 1114 such as a keyboard, a pointing device, a display 1124, and so on that enable a user to interact with computing device 1100. Computing device 1100 may also include any devices, e.g., network card, modem, etc., that enable computing device 1100 to communicate with one or more other computing devices. Such communication may occur, for example, via I/O interfaces 1121. Still yet, computing device 1100 may communicate with one or more networks such as a local area network (‘LAN’), a general wide area network (‘WAN’), and/or a public network, e.g., the Internet, via network adapter 1120. As depicted, network adapter 1120 communicates with the other components of computing device 1100 via bus 1118. It should be understood that although not shown, other hardware and/or software components could be used in conjunction with computing device 1100. Examples include, but are not limited to, microcode, device drivers, redundant processing units, external disk drive arrays, RAID systems, tape drives, and data archival storage systems, and so on.

Each of the processes, methods, and algorithms described in the preceding sections may be embodied in, and fully or partially automated by, code modules executed by one or more computers or computer processors. The code modules may be stored on any type of non-transitory computer-readable medium or computer storage device, such as hard drives, solid state memory, optical disc, and/or the like. The processes and algorithms may be implemented partially or wholly in application-specific circuitry. The results of the disclosed processes and process steps may be stored, persistently or otherwise, in any type of non-transitory computer storage such as, e.g., volatile or non-volatile storage.

The various features and processes described above may be used independently of one another, or may be combined in various ways. All possible combinations and sub-combinations are intended to fall within the scope of this disclosure. In addition, certain method or process blocks may be omitted in some implementations. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The example blocks or states may be performed in serial, in parallel or in some other manner. Blocks or states may be added to or removed from the disclosed example embodiments. The example systems and components described herein may be configured differently than described. For example, elements may be added to, removed from, or rearranged compared to the disclosed example embodiments.

It will also be appreciated that various items are illustrated as being stored in memory or on storage while being used, and that these items or portions of thereof may be transferred between memory and other storage devices for purposes of memory management and data integrity. Alternatively, in other embodiments some or all of the software modules and/or systems may execute in memory on another device and communicate with the illustrated computing systems via inter-computer communication. Furthermore, in some embodiments, some or all of the systems and/or modules may be implemented or provided in other ways, such as at least partially in firmware and/or hardware, including, but not limited to, one or more application-specific integrated circuits (ASICs), standard integrated circuits, controllers (e.g., by executing appropriate instructions, and including microcontrollers and/or embedded controllers), field-programmable gate arrays (FPGAs), complex programmable logic devices (CPLDs), etc. Some or all of the modules, systems and data structures may also be stored (e.g., as software instructions or structured data) on a computer-readable medium, such as a hard disk, a memory, a network, or a portable media article to be read by an appropriate drive or via an appropriate connection. The systems, modules, and data structures may also be transmitted as generated data signals (e.g., as part of a carrier wave or other analog or digital propagated signal) on a variety of computer-readable transmission media, including wireless-based and wired/cable-based media, and may take a variety of forms (e.g., as part of a single or multiplexed analog signal, or as multiple discrete digital packets or frames). Such computer program products may also take other forms in other embodiments. Accordingly, the present invention may be practiced with other computer system configurations.

Some portions of the above description present the features of the present invention in terms of algorithms and symbolic representations of operations, or algorithm-like representations, of operations on information/data. These algorithmic or algorithm-like descriptions and representations are the means used by those of skill in the art to most effectively and efficiently convey the substance of their work to others of skill in the art. These operations, while described functionally or logically, are understood to be implemented by computer programs or computing systems. Furthermore, it has also proven convenient at times to refer to these arrangements of operations as steps or modules or by functional names, without loss of generality.

The present invention also relates to an apparatus or system for performing the operations described herein. This apparatus or system may be specifically constructed for the required purposes, or the apparatus or system can comprise a general-purpose system selectively activated or configured/reconfigured by a computer program stored on a computer program product as discussed herein that can be accessed by a computing system or other device.

Those of skill in the art will readily recognize that the algorithms and operations presented herein are not inherently related to any particular computing system, computer architecture, computer or industry standard, or any other specific apparatus. Various general-purpose systems may also be used with programs in accordance with the teaching herein, or it may prove more convenient/efficient to construct more specialized apparatuses to perform the required operations described herein. The required structure for a variety of these systems will be apparent to those of skill in the art, along with equivalent variations. In addition, the present invention is not described with reference to any particular programming language and it is appreciated that a variety of programming languages may be used to implement the teachings of the present invention as described herein, and any references to a specific language or languages are provided for illustrative purposes only and for enablement of the contemplated best mode of the invention at the time of filing.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without author input or prompting, whether these features, elements, and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

While certain example embodiments have been described, these embodiments have been presented by way of example only, and are not intended to limit the scope of the inventions disclosed herein. Thus, nothing in the foregoing description is intended to imply that any particular feature, characteristic, step, module, or block is necessary or indispensable. Indeed, the novel methods and systems described herein may be embodied in a variety of other forms; furthermore, various omissions, substitutions and changes in the form of the methods and systems described herein may be made without departing from the spirit of the inventions disclosed herein. The accompanying claims and their equivalents are intended to cover such forms or modifications as would fall within the scope and spirit of certain of the inventions disclosed herein.

What is claimed is:

1. A system for standardizing data to generate a profile, comprising:
a computing device in secure communication with a cloud database, wherein the computing device comprises a processor, and at least one memory communicatively coupled to the processor, the memory comprising instructions that cause the processor to:
receive a data file associated with a user and at least one third-party content service provider, wherein the data file comprises user information in a first data format;
convert the data file from the first data format to a common format;
analyze the converted data file to identify user information and attributes related to user activity on the at least one third-party content service provider;
update the cloud database with the user information and identified attributes, wherein the cloud database comprises at least one of: data files associated with other users, metadata from a third-party content service provider, previously identified attributes, and user metadata; and
generate a profile comprising a subset of information from the cloud database, the subset of information comprising at least one attribute and user information.

2. The system of claim 1, wherein the common format is a universal data interchange format (UDIF) or JavaScript Object Notation (JSON).

3. The system of claim 1, wherein the first data format is a CSV, HTML, XML, PDF, TXT, DOC, DOCX, ZIP, XLS, XLSX, or JS.

4. The system of claim 1, wherein the user information comprises one or more of: a name, user name, user activity data, video stream information, user communications, texts, demographic information, biometric data, health data, and metadata associated with the user.

5. The system of claim 4, wherein demographic information includes at least one of: an email, a phone number, a gender, a date of birth, and a zip code.

6. The system of claim 1, wherein the third-party content service provider is at least one of:
a social media network, a streaming service, an online account provider, a data management service, an online service, a health service, and a website.

7. The system of claim 1, wherein the data file in the first format is stored in a second cloud database comprising data files and user information collected from a plurality of third-party service providers.

8. The system of claim 1, wherein the data file is uploaded via a user interface on a remote computing device.

9. The system of claim 8, wherein the remote computing device is at least one of: a laptop, a personal computing device, a wearable computing device, and a mobile computing device.

10. The system of claim 1, wherein the instructions that cause the processor the convert the data format comprises:
identifying a key associated with the first format of a data file; and
executing a script based on the key to convert the data file to the common format.

11. The system of claim 1, further comprising instructions that cause the processor to: store the generated profile and the converted data files in the cloud database

12. The system of claim 1, further comprising instructions that cause the processor to:
receive a request for at least one attribute or user information of interest; and
generate the profile based on the request.

13. A method for standardizing information to generate a profile, comprising:
receive a data file associated with a user and at least one third-party content service provider, wherein the data file comprises user information in a first data format;
convert the data file from the first data format to a common format;
analyze the converted data file to identify user information and attributes related to user activity on the at least one third-party content service provider;
update a secure cloud database with the user information and identified attributes, wherein the cloud database comprises at least one of: data files associated with other users, metadata from a third-party content service provider, and user metadata, and previously identified attributes; and
generate a profile comprising a subset of information from the cloud database, the subset of information comprising at least one attribute and user information.

14. The method of claim 13, wherein the common format is a universal data interchange format (UDIF) or JavaScript Object Notation (JSON) and the first data format is a CSV, HTML, XML, PDF, TXT, DOC, DOCX, ZIP, XLS, XLSX, or JS.

15. The system of claim 1, wherein the user information comprises one or more of: a name, user name, user activity data, video stream information, user communications, texts, demographic information, biometric data, health data, and metadata associated with the user.

16. The method of claim 13, wherein converting the data file comprises:
identifying a key associated with the first format of a data file; and
executing a script based on the key to convert the data file to the common format.

17. The method of claim 13, further comprising:
receiving a request for at least one attribute or user information of interest; and
generating the profile based on the request.

18. A system for standardizing and processing user information, comprising:
a computing device for uploading data files associated with a user on at least one third-party content service provider, wherein the data files comprise a first data format;
a secure cloud database storing a plurality of content identifiers collected from at least one of: a plurality of data files, metadata from content service providers, and user input;
a processor in communication with at least one memory, the memory comprising instructions that cause the processor to at least:
receive data files from the computing device;
convert the data files to a common format;
extract information indicative of user activity, based on previously identified content in the secure cloud database;
process the user activity information and categorize based on user activity types; and
output a subset of the user activity information to the computing device.

19. The system of claim 11, wherein the data files comprise user information including one or more of: a name, user name, user activity data, video stream information, user communications, texts, demographic information, biometric data, health data, and metadata associated with the user.

20. The system of claim 11, wherein processing comprises storing, in the database, at least one of a user profile, user identifier, a data file location, an upload time, and an upload status.
